(19) United States
(12) Patent Application Publication
(10) Pub. No.: US 2011/0311150 A1
(43) Pub. Date: Dec. 22, 2011

(54) IMAGE PROCESSING APPARATUS

(75) Inventor: Masayoshi Okamoto, Daito-shi (JP)

(73) Assignee: SANYO ELECTRIC CO., LTD., Osaka (JP)

(21) Appl. No.: 13/163,053

(22) Filed: Jun. 17, 2011

(30) Foreign Application Priority Data
Jun. 17, 2010 (JP) 2010-138423

(51) Int. Cl. G06K 9/62

(52) U.S. Cl. 382/224

(57) ABSTRACT

An image processing apparatus includes a taker. A taker takes an image. A searcher searches for one or at least two face images from the image taken by the taker. A first designator designates each of the one or at least two face images discovered by the searcher. A holder holds a plurality of face characteristics respectively corresponding to a plurality of ages. A detector detects a facial expression of the face image designated by the first designator. An estimator estimates an age of a person equivalent to the face image designated by the first designator based on the plurality of face characteristics held by the holder and the facial expression detected by the detector. An adjuster adjusts a quality of the image taken by the taker with reference to an estimated result of the estimator.

### CROSS REFERENCE OF RELATED APPLICATION

The disclosure of Japanese Patent Application No. 2010-138423, which was filed on Jun. 17, 2010, is incorporated here by reference.

### BACKGROUND OF THE INVENTION

1. Field of the Invention

The present invention relates to an image processing apparatus. More particularly, the present invention relates to an image processing apparatus which estimates an age of a person appeared in an image.

2. Description of the Related Art

According to one example of this type of apparatus, in an age estimating device which performs an image process on an image of a face of a measurement-target person photographed by an image input device and estimates an age of the measurement-target person, the image of the face of the measurement-target person is photographed, and then, a plurality of characteristic amounts being different from each other are extracted from the acquired image of the face. Based on the extracted plurality of characteristic amounts, a plurality of ages are estimated by a plurality of age estimators. Based on a distribution of the plurality of ages estimated by the plurality of age estimators, an estimated age is determined. The determined estimated age is displayed by a displayer.

However, in the above-described apparatus, upon estimating the age based on the characteristic amount extracted from the face image, a facial expression is never referred to. Thus, when a quality of the image is adjusted with reference to the estimated age, depending on a facial expression of the face detected from a scene, the quality of the image may be deteriorated.

### SUMMARY OF THE INVENTION

An image processing apparatus according to the present invention, comprises: a taker which takes an image; a searcher which searches for one or at least two face images from the image taken by the taker; a first designator which designates each of the one or at least two face images discovered by the searcher; a holder which holds a plurality of face characteristics respectively corresponding to a plurality of ages; a detector which detects a facial expression of the face image designated by the first designator; an estimator which estimates an age of a person equivalent to the face image designated by the first designator, based on the plurality of face characteristics held by the holder and the facial expression detected by the detector; and an adjuster which adjusts a quality of the image taken by the taker with reference to an estimated result of the estimator.

According to the present invention, a computer program embodied in a tangible medium, which is executed by a processor of an image processing apparatus, the program comprises: a taking instruction to take an image; a searching instruction to search for one or at least two face images from the image taken based on the taking instruction; a first designating instruction to designate each of the one or at least two face images discovered based on the searching instruction; a holding instruction to hold a plurality of face characteristics respectively corresponding to a plurality of ages; a detecting instruction to detect a facial expression of the face image designated based on the first designating instruction; an estimating instruction to estimate an age of a person equivalent to the face image designated based on the first designating instruction, based on the plurality of face characteristics held based on the holding instruction and the facial expression detected based on the detecting instruction; and an adjusting instruction to adjust a quality of the image taken based on the taking instruction with reference to an estimated result based on the estimating instruction.

According to the present invention, an imaging control method executed by an image processing apparatus, the imaging control method, the imaging control method comprises: a taking step of taking an image; a searching step of searching for one or at least two face images from the image taken by the taking step; a first designating step of designating each of the one or at least two face images discovered by the searching step; a holding step of holding a plurality of face characteristics respectively corresponding to a plurality of ages; a detecting step of detecting a facial expression of the face image designated by the first designating step; an estimating step of estimating an age of a person equivalent to the face image designated by the first designating step, based on the plurality of face characteristics held by the holding step and the facial expression detected by the detecting step; and an adjusting step of adjusting a quality of the image taken by the taking step with reference to an estimated result of the estimating step.

The above described features and advantages of the present invention will become more apparent from the following detailed description of the embodiment when taken in conjunction with the accompanying drawings.

### BRIEF DESCRIPTION OF THE DRAWINGS

FIG. 1 is a block diagram showing a basic configuration of one embodiment of the present invention;

FIG. 2 is a block diagram showing a configuration of one embodiment of the present invention;

FIG. 3 is an illustrative view showing one example of an allocation state of an evaluation area in an imaging surface;

FIG. 4 is an illustrative view showing one example of a configuration of an age-group designation register applied to the embodiment in FIG. 2;

FIG. 5 is an illustrative view showing one example of a configuration of a standard face dictionary applied to the embodiment in FIG. 2;

FIG. 6 is an illustrative view showing one example of a configuration of a face-frame structure register applied to the embodiment in FIG. 2;

FIG. 7 is an illustrative view showing one example of a face-detection frame structure used in an age-group designating task and a reproducing task;

FIG. 8 is an illustrative view showing one example of a face detecting process in the age-group designating task and the reproducing task;

FIG. 9 is an illustrative view showing one example of an image displayed on a monitor screen in an imaging mode;

FIG. 10 is an illustrative view showing one example of a configuration of a recognized face register applied to the embodiment in FIG. 2;

FIG. 11 is an illustrative view showing one example of a configuration of a finalization register applied to the embodiment in FIG. 2;

FIG. 12 is an illustrative view showing one example of a configuration of an age and gender dictionary applied to the embodiment in FIG. 2;

FIG. 13(A) is an illustrative view showing one example of a face image before a correction;

FIG. 13(B) is an illustrative view showing one example of a face image after the correction;

FIG. 14 is an illustrative view showing one example of a configuration of a focus register applied to the embodiment in FIG. 2;

FIG. 15 is an illustrative view showing another example of the image displayed on the monitor screen in the imaging mode;

FIG. 16 is an illustrative view showing one example of an image displayed on the monitor screen in a reproducing mode;

FIG. 17(A) is an illustrative view showing another example of the face image before the correction;

FIG. 17(B) is an illustrative view showing another example of the face image after the correction;

FIG. 18 is an illustrative view showing another example of the image displayed on the monitor screen in the reproducing mode;

FIG. 19 is a flowchart showing one portion of behavior of a CPU applied to the embodiment in FIG. 2;

FIG. 20 is a flowchart showing another portion of the behavior of the CPU applied to the embodiment in FIG. 2;

FIG. 21 is a flowchart showing still another portion of the behavior of the CPU applied to the embodiment in FIG. 2;

FIG. 22 is a flowchart showing yet another portion of the behavior of the CPU applied to the embodiment in FIG. 2;

FIG. 23 is a flowchart showing another portion of the behavior of the CPU applied to the embodiment in FIG. 2;

FIG. 24 is a flowchart showing still another portion of the behavior of the CPU applied to the embodiment in FIG. 2;

FIG. 25 is a flowchart showing yet another portion of the behavior of the CPU applied to the embodiment in FIG. 2;

FIG. 26 is a flowchart showing another portion of the behavior of the CPU applied to the embodiment in FIG. 2;

FIG. 27 is a flowchart showing still another portion of the behavior of the CPU applied to the embodiment in FIG. 2;

FIG. 28 is a flowchart showing yet another portion of the behavior of the CPU applied to the embodiment in FIG. 2;

FIG. 29 is a flowchart showing another portion of the behavior of the CPU applied to the embodiment in FIG. 2;

FIG. 30 is a flowchart showing still another portion of the behavior of the CPU applied to the embodiment in FIG. 2;

FIG. 31 is a flowchart showing yet another portion of the behavior of the CPU applied to the embodiment in FIG. 2; and

FIG. 32 is a block diagram showing a configuration of another embodiment of the present invention.

### DETAILED DESCRIPTION OF THE PREFERRED EMBODIMENTS

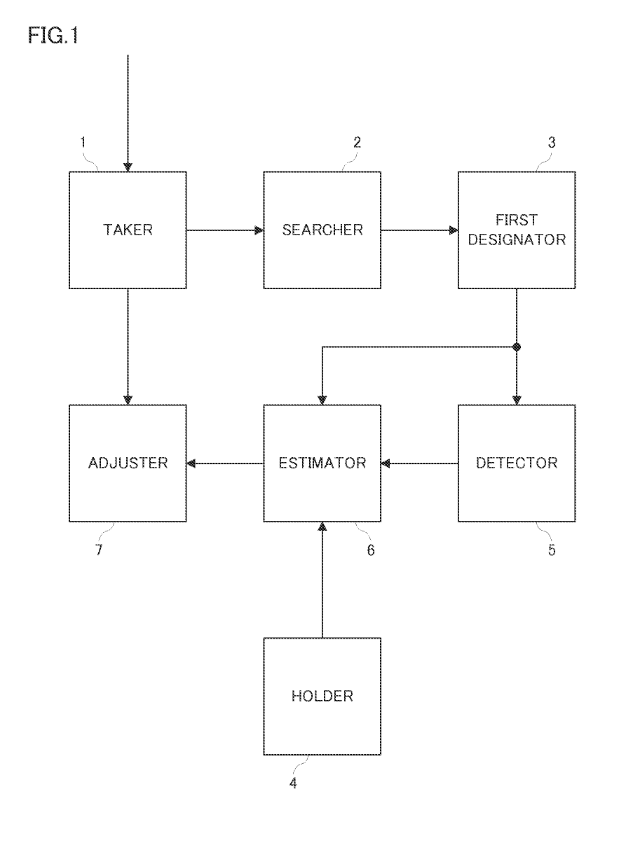

With reference to FIG. 1, an image processing apparatus according to one embodiment of the present invention is basically configured as follows: A taker 1 takes an image. A searcher 2 searches for one or at least two face images from the image taken by the taker 1. A first designator 3 designates each of the one or at least two face images discovered by the searcher 2. A holder 4 holds a plurality of face characteristics respectively corresponding to a plurality of ages. A detector 5 detects a facial expression of the face image designated by the first designator 3. An estimator 6 estimates an age of a person equivalent to the face image designated by the first designator 3 based on the plurality of face characteristics held by the holder 4 and the facial expression detected by the detector 5. An adjuster 7 adjusts a quality of the image taken by the taker 1 with reference to an estimated result of the estimator 6.

Upon estimating an age of the face image, in addition to the plurality of face characteristics respectively corresponding to the plurality of ages, a facial expression of a face image which is a target of the estimation is referred to. By adjusting a quality of the image with reference to the age thus estimated, the quality of the image is improved.

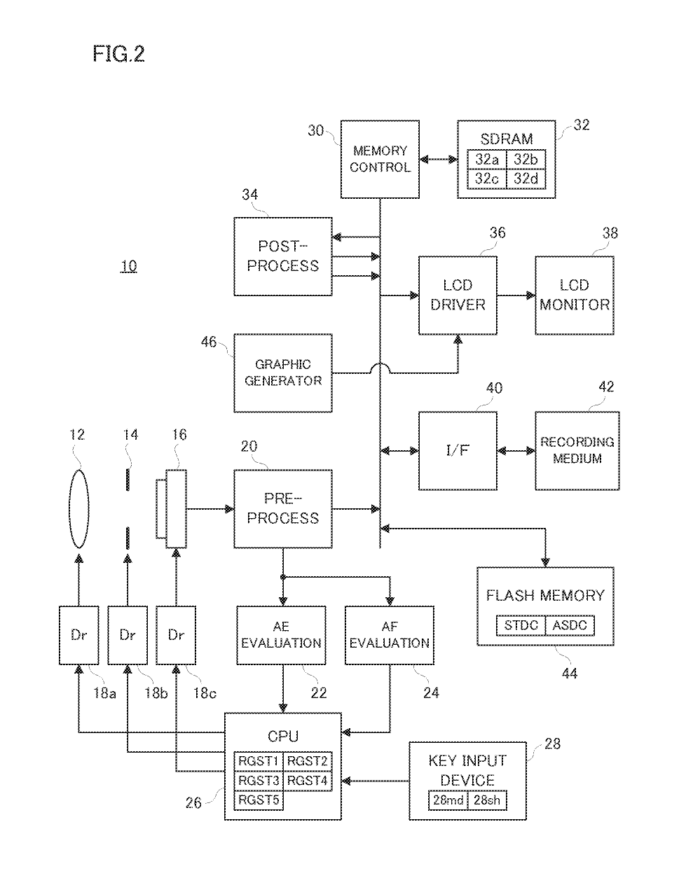

With reference to FIG. 2, a digital camera 10 according to one embodiment includes a focus lens 12 and an aperture unit 14 driven by drivers 18a and 18b, respectively. An optical image of a scene that underwent these components enters, with irradiation, an imaging surface of an imager 16, and is subjected to a photoelectric conversion. Thereby, electric charges representing the image are produced.

When a power source is applied, under a main task, a CPU 26 determines a setting (i.e., an operation mode at a current time point) of a mode selector switch 28md arranged in a key input device 28. If the operation mode at the current time point is an imaging mode, an imaging task and an age-group designating task are started up. If the operation mode at the current time point is a reproducing mode, a reproducing task is started up.

When the imaging mode is selected, in order to execute a moving-image taking process, the CPU 26 commands a driver 18c to repeat an exposure procedure and an electric-charge reading-out procedure under the imaging task. In response to a vertical synchronization signal Vsync periodically generated from an SG (Signal Generator) not shown, the driver 18c exposes the imaging surface and reads out the electric charges produced on the imaging surface in a raster scanning manner. From the imager 16, raw image data that is based on the read-out electric charges is cyclically outputted.

A pre-processing circuit 20 performs processes, such as digital clamp, pixel defect correction, gain control and etc., on the raw image data outputted from the imager 16. The raw image data on which these processes are performed is written into a raw image area 32a of an SDRAM 32 through a memory control circuit 30.

A post-processing circuit 34 reads out the raw image data accommodated in the raw image area 32a through the memory control circuit 30, performs processes such as a color separation process, a white balance adjusting process, a YUV converting process and etc., on the read-out raw image data. Moreover, the post-processing circuit 34 executes a zoom process for displaying and a zoom process for searching on the image data that comply with a YUV format, in a parallel manner. As a result, display image data and search image data that comply with the YUV format are individually created. The display image data is written into a display image area 32b of the SDRAM 32 by the memory control circuit 30. The search image data is written into a search image area 32c of the SDRAM 32 by the memory control circuit 30.

An LCD driver 36 repeatedly reads out the display image data accommodated in the display image area 32b through the memory control circuit 30, and drives an LCD monitor 38 based on the read-out image data. As a result, a real-time moving image (a live view image) of the scene is displayed on a monitor screen.

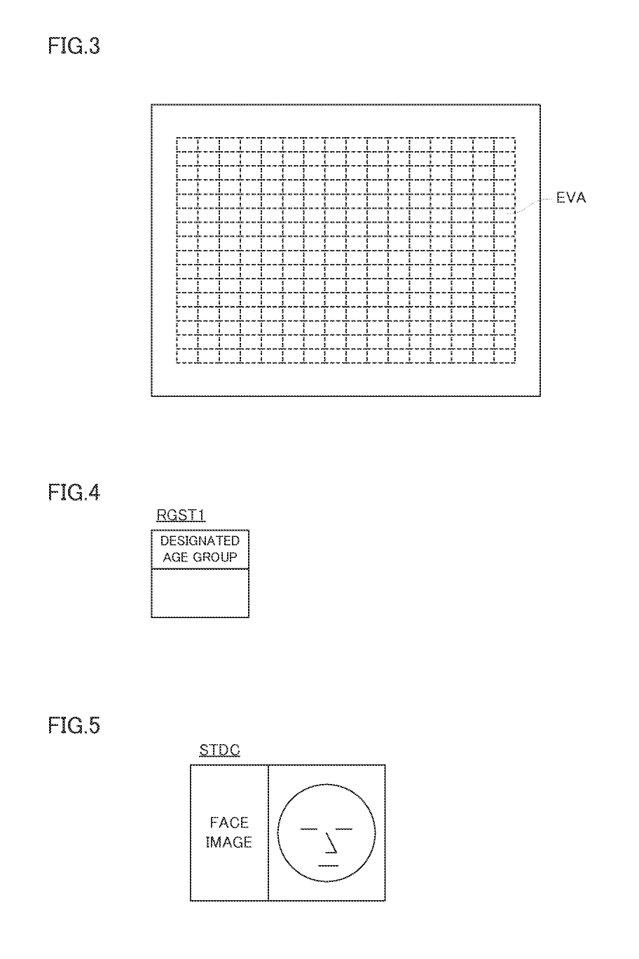

With reference to FIG. 3, an evaluation area EVA is allocated to a center of the imaging surface. The evaluation area EVA is divided into 16 portions in each of a horizontal direction and a vertical direction; therefore, 256 divided areas form the evaluation area EVA. Moreover, in addition to the above-described processes, the pre-processing circuit 20 shown in FIG. 2 executes a simple RGB converting process for simply converting the raw image data into RGB data.

An AE evaluating circuit 22 integrates, out of the RGB data produced by the pre-processing circuit 20, RGB data belonging to the evaluation area EVA at every time the vertical synchronization signal Vsync is generated. Thereby, 256 integral values (256 AE evaluation values) are outputted from the AE evaluating circuit 22 in response to the vertical synchronization signal Vsync.

An AF evaluating circuit 24 integrates, out of the RGB data produced by the pre-processing circuit 20, a high-frequency component of the RGB data belonging to the evaluation area EVA at every time the vertical synchronization signal Vsync is generated. Thereby, 256 integral values (256 AF evaluation values) are outputted from the AF evaluating circuit 24 in response to the vertical synchronization signal Vsync.

When a shutter button 28sh is in a non-operated state, under the imaging task, the CPU 26 executes a simple AE process that is based on output from the AE evaluating circuit 22 so as to calculate an appropriate EV value. An aperture amount and an exposure time period that define the calculated appropriate EV value are set to the drivers 18b and 18c, respectively, and as a result, a brightness of the live view image is adjusted approximately.

When a shutter button 28sh is half depressed, under the imaging task, the CPU 26 executes a strict AE process that is based on the output from the AE evaluating circuit 22 so as to calculate an optimal EV value. An aperture amount and an exposure time period that define the optimal EV value are set to the drivers 18b and 18c, respectively, and as a result, the brightness of the live view image is adjusted approximately. Upon completion of the strict AE process, as long as nothing is registered in an age-group designation register RGST1 described later, the CPU 26 executes a normal AF process under the imaging task. The AF process is executed by using a hill-climbing system referring to output of the AF evaluating circuit 24, and the focus lens 12 is set to a focal point. Thereby, a sharpness of the live view image is improved.

When the shutter button 28sh is fully depressed, a still-image taking process and a recording process are executed. One frame of the display image data at a time point at which the shutter button 28sh is fully depressed is taken by the still-image taking process into a still-image area 32d. The taken one frame of the image data is read out from the still-image area 32d by an I/F 40 which is started up in association with the recording process, and is recorded on a recording medium 42 in a file format.

When the reproducing mode is selected, the CPU 26 designates the latest image file recorded on the recording medium 42 and commands the I/F 40 and the LCD driver 36 to execute a reproducing process in which the designated image file is noticed.

The I/F 40 reads out the image data of the designated image file from the recording medium 42, and writes the read-out image data into the display image area 32b of the SDRAM 32 through the memory control circuit 30. The LCD driver 36 reads out the image data accommodated in the display image area 32b through the memory control circuit 30, and an optical image corresponding to the read-out image data is generated. As a result, the generated optical image is displayed on the LCD monitor 38.

By an operator operating the key input device 28, the CPU 26 designates a succeeding image file or a preceding image file as a reproduced-image file. The designated-image file is subjected to a reproducing process similar to that described above, and as a result, a display of the LCD monitor 38 is updated.

Moreover, when an age-group designating operation is performed by the operator through the key input device 28 while displaying the live view image by the simple AE process, under the imaging task, the CPU 26 registers the designated age group on the age-group designation register RGST1 shown in FIG. 4. The age-group designating operation is an operation for executing an AF process giving priority to a face position of a person having an age belonging to an age group desired by the operator.

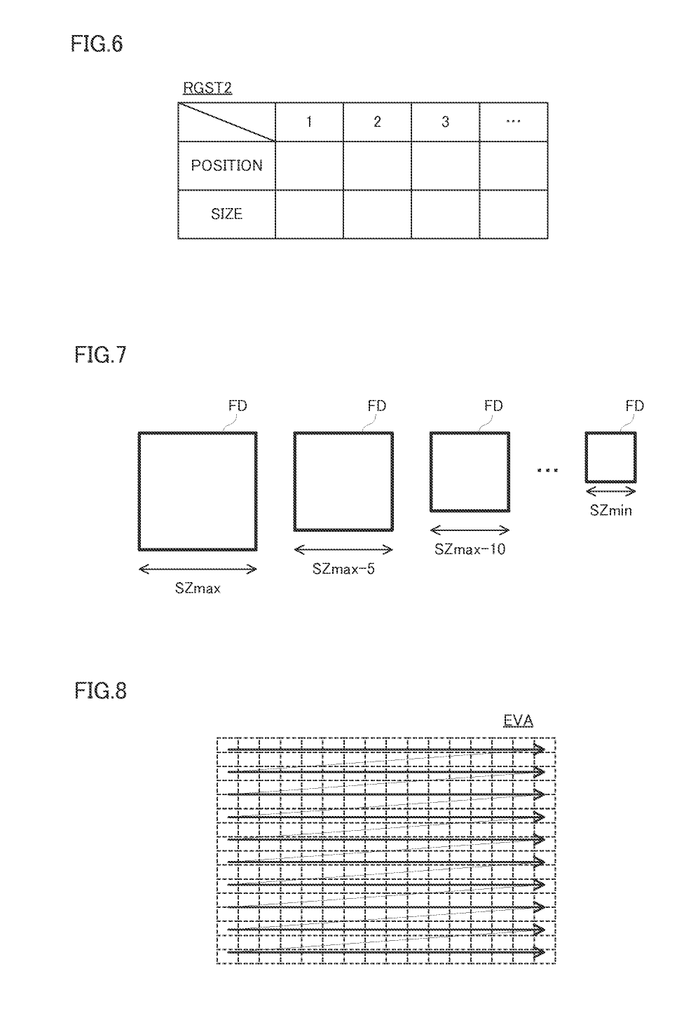

Under the age-group designating task executed in parallel with the imaging task, the CPU 26 executes an age estimating process in order to estimate an age of a person by searching for a face image of the person from the search image data accommodated in the search image area 32c. Upon the age estimating process, the CPU 26 converts the search image data accommodated in the search image area 32c into QVGA data which has horizontal 320 pixels×vertical 240 pixels (resolution: QVGA). Thereafter, the face image of the person is searched from the QVGA data. For the age estimating process, a standard face dictionary STDC shown in FIG. 5, a face-detection frame structure register RGST2 shown in FIG. 6 and a plurality of face-detection frame structures FD, FD, FD, . . . shown in FIG. 7 are prepared.

The face-detection frame structure FD is moved in a raster scanning manner corresponding to the evaluation area EVA on an image of the QVGA data (see FIG. 8), at every time the vertical synchronization signal Vsync is generated. The size of the face-detection frame structure FD is reduced by a scale of “5” from “200” to “20” at every time the raster scanning is ended.

The CPU 26 reads out image data belonging to the face-detection frame structure FD from the QVGA data so as to calculate a characteristic amount of the read-out image data. The calculated characteristic amount is compared with a characteristic amount of a face image registered in the standard face dictionary STDC. When a matching degree exceeds a reference value REF1, it is regarded that the face image is discovered from the face-detection frame structure FD, and a variable CNT is incremented. Furthermore, a position and a size of the face-detection frame structure FD at a current time point are registered as a position and a size of the face-detection frame structure surrounding the discovered face image, on the face-detection frame structure register RGST2.

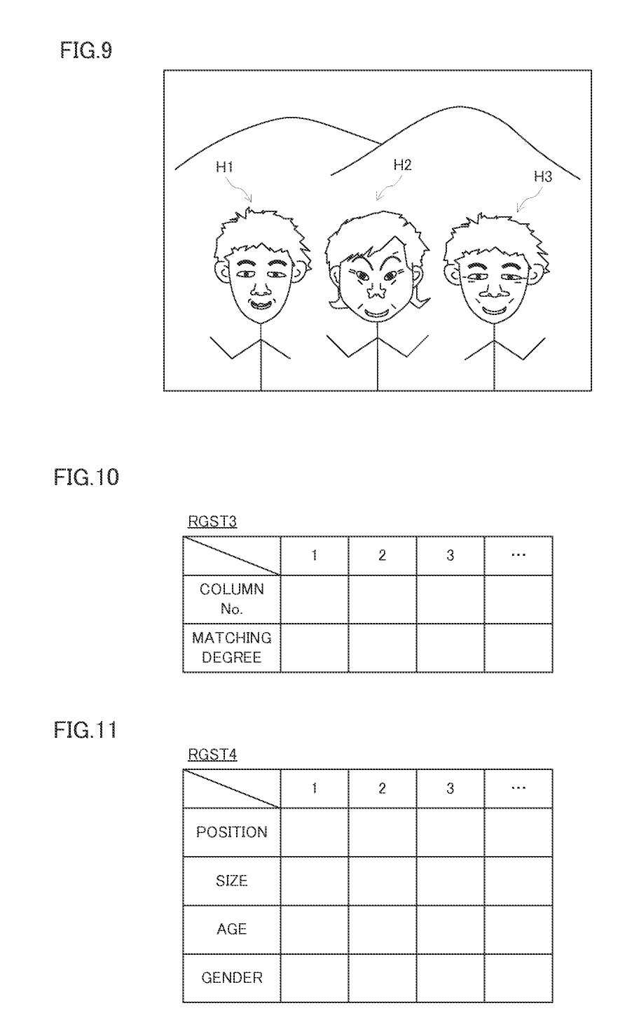

Thus, when a scene shown in FIG. 9 is captured, face images of persons H1, H2 and H3 are detected, and the position and size of the face-detection frame structure FD surrounding the detected face image are registered on the face-detection frame structure register RGST2. A position and a size of the face-detection frame structure FD corresponding to the person H1 is described in the first column of the face-detection frame structure register RGST2, a position and a size of the face-detection frame structure FD corresponding to the person H2 is described in the second column of the face-detection frame structure register RGST2, and a position and a size of the face-detection frame structure FD corresponding to the person H3 is described in the third column of the face-detection frame structure register RGST2. At a time point at which the position and size of the face-detection frame structure FD corresponding to the person H3 is described, the variable CNT indicates “3”.

Subsequently, the CPU 26 designates CNT face-detection frame structures registered in the face-detection frame structure register RGST2 in order. Image data belonging to the designated face-detection frame structure is subjected to a following face recognition process.

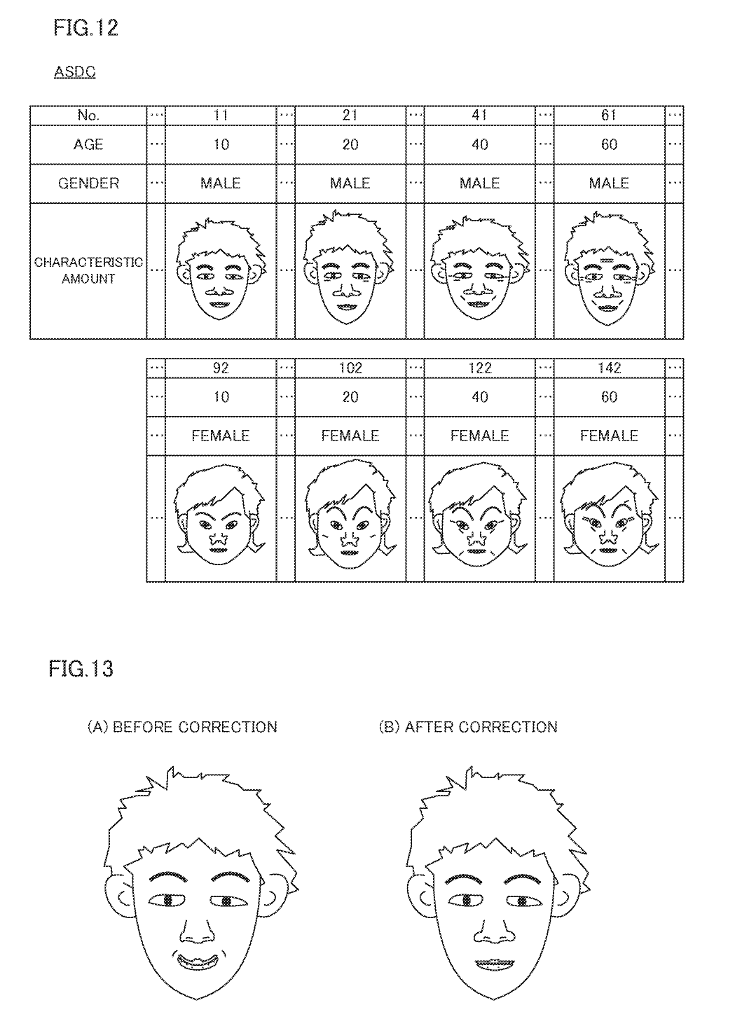

Prior to the face recognition process, the CPU 26 converts the search image data accommodated in the search image area 32c into VGA data which has horizontal 640 pixels×vertical 480 pixels (resolution: VGA) in order to improve a processing speed. Subsequently, the CPU 26 converts the position and size of the face-detection frame structure registered in the face-detection frame structure register RGST2 into the one on the VGA data and rewrites the face-detection frame structure register RGST2. Moreover, for the face recognition process, a recognized face register RGST3 shown in FIG. 10, a finalization register RGST4 shown in FIG. 11 and an age and gender dictionary ASDC shown in FIG. 12 are prepared.

In the age and gender dictionary ASDC, for example, a characteristic amount of a face image of an average person in each of ages from less than a year old to 80 years old is contained with each gender. It is noted that, in FIG. 12, the face image of the person is allocated, however, in reality, the characteristic amount of the face image of the person is allocated. Moreover, in this embodiment, a smile degree of the face image is referred to upon estimating the age of the person, however, all the smile degrees of the face image in which each characteristic amount contained in the age and gender dictionary ASDC indicates are zero.

In the face recognition process, firstly, image data belonging to a designated-face-detection frame structure is read out from the VGA data so as to calculate a smile degree of the read-out image data. A characteristic amount of the image data belonging to the designated-face-detection frame structure is corrected so that a difference between the calculated smile degree and the smile degree of each characteristic amount contained in the age and gender dictionary ASDC is inhibited or resolved. Since the smile degree of each characteristic amount contained in the age and gender dictionary ASDC is zero, the characteristic amount of the image data belonging to the designated-face-detection frame structure is corrected so that the smile degree becomes zero.

For example, in a case where a characteristic amount of the face image of the person H1 shown in FIG. 9 is corrected, a smile degree to be calculated is 70. Since the smile degree is different from the smile degree (=0) of each characteristic amount contained in the age and gender dictionary ASDC, the characteristic amount of the face image of the person H1 is corrected so that the smile degree becomes zero. As a result, a facial expression of the face image of the person H1 changes from FIG. 13(A) to FIG. 13(B).

Subsequently, a variable K is set to each of “1” to “Kmax”, and the corrected characteristic amount is compared with a characteristic amount described in a K-th column of the age and gender dictionary ASDC. It is noted that “Kmax” is equivalent to the total number of the characteristic amounts contained in the age and gender dictionary ASDC. When a matching degree exceeds a reference value REF2, a column number (=K) of a characteristic amount in a matching destination and the matching degree are registered on the recognized face register RGST3 shown in FIG. 10.

When at least one column number is registered in the recognized face register RGST3, a position and a size of the face-detection frame structure corresponding to a maximum matching degree, and an age and a gender described in a column of the age and gender dictionary ASDC indicated by a column number corresponding to the maximum matching degree are registered on the finalization register RGST4 shown in FIG. 11. The age registered in the finalization register RGST4 is estimated as the age of the person of the face image belonging to the face-detection frame structure.

Upon completion of the face recognition process for the image data belonging to the CNT face-detection frame structures, the CPU 26 determines whether or not there is any registration in the finalization register RGST4. When there is the registration, the CPU 26 sets a flag FLG_RCG to “1” and converts the position and size of the face-detection frame structure registered in the finalization register RGST4 into the one on the search image data so as to rewrite the finalization register RGST4. On the other hand, when nothing is registered in the finalization register RGST4, the flag FLG_RCG is set to “0”.

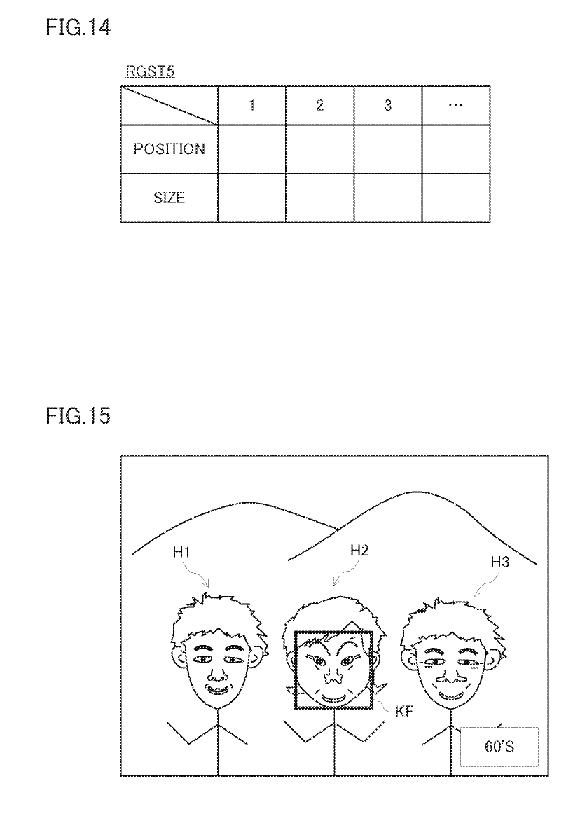

Thus, upon completion of the age estimating process, in a case where the flag FLG_RCG is set to “1” and the designated age group is registered in the age-group designation register RGST1, under the age-group designating task, the CPU 26 compares the age-group designation register RGST1 with the finalization register RGST4. A variable M is set to each of “1” to “Mmax”, and an estimated age described in an M-th column of the finalization register RGST4 is compared with the designated age group registered in the age-group designation register RGST1. When the estimated age is included in the designated age group, a position and a size of the face-detection frame structure described in the M-th column of the finalization register RGST4 are registered on a focus register RGST5 shown in FIG. 14. It is noted that “Mmax” is equivalent to the total number of the registered ages in the finalization register RGST4.

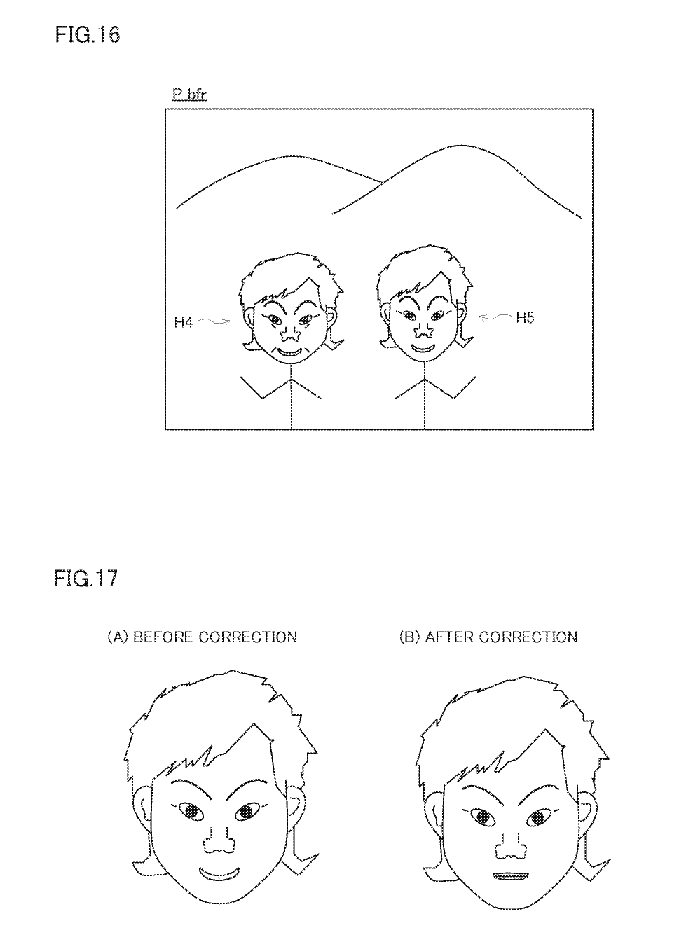

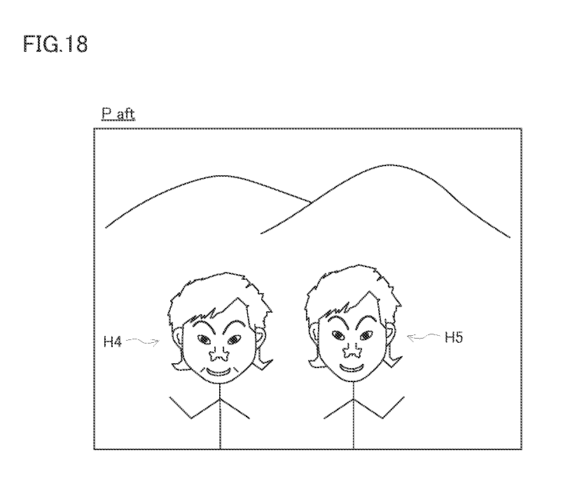

When the designated age group is registered in the age-group designation register RGST1 at a time point of completion of the strict AE process by half-depressing the shutter button, under the imaging task, the CPU 26 applies a designated-age-group display command to a graphic generator 46. In the designated-age-group display command, the designated age group registered in the age-group designation register RGST1 is described. When the designated-age-group display command is applied, the graphic generator 46 creates graphic data representing the designated age group so as to apply the created graphic data to the LCD driver 36. As a result, as shown in FIG. 15, the designated age group registered in the age-group designation register RGST1 is displayed at a lower right of the monitor screen with the live view image.

After the designated-age-group display command is issued, the CPU 26 waits for a completion of the age-group designating task executed in parallel with the imaging task. When the position and size of the face-detection frame structure are registered on the focus register RGST5 by the process of the age-group designating task, the CPU 26 issues a face-frame-structure display command toward the graphic generator 46. In the face-frame-structure display command, the position and size of the face-detection frame structure registered in the focus register RGST5 is described. When there is no registration in the focus register RGST5, i.e., when the age estimated in the age estimating process is not included in any of the age groups designated by the age-group designating operation, the face-frame-structure display command is non-issued.

When the face-frame-structure display command is applied, the graphic generator 46 creates graphic data representing a face-frame structure KF so as to apply the created graphic data to the LCD driver 36. The graphic data is created with reference to the position and size described in the face-frame-structure display command. As a result, the face-frame structure KF is displayed in a manner to surround a face image of a person having the estimated age belonging to the age group designated by the age-group designating operation.

In an example shown in FIG. 9, when the persons H1, H2 and H3 are respectively estimated as 20 years old, 60 years old and 40 years old, and “60's” is designated by the age-group designating operation, the face-frame structure KF is displayed in a manner to surround the face image of the person H2 (see FIG. 15). Subsequently, the CPU 26 executes the AF process giving priority to the face position of the person H2. As a result, a sharpness of the face image of the person H2 is improved. It is noted that, when the face-frame-structure display command is non-issued, the normal AF process is executed. Processes after the shutter button 28sh is fully depressed are executed as described above.

When a beautiful skin process operation is performed via the key input device 28 in a case where the reproducing mode is selected, image data of an image file under reproduction is written into the search image area 32c of the SDRAM 32. Subsequently, under the reproducing task, the CPU 26 executes the age estimating process. It is noted that, the process executed here is similar to the age estimating process executed under the imaging task.

Thus, when the beautiful skin process operation is performed on a reproduced image P_bfr shown in FIG. 16, the face images of the persons H4 and H5 are detected, and each position and size of the face-detection frame structure FD surrounding each of the detected face images are registered on the face-detection frame structure register RGST2. The face-detection frame structures registered in the face-detection frame structure register RGST2 are designated in order, and the face recognition process is performed on each of them.

For example, as to the face image of the person H5 shown in FIG. 16, a smile degree to be calculated is 60, and the characteristic amount of the face image of the person H5 is corrected so that the smile degree becomes zero. As a result, a facial expression of the face image of the person H5 changes from FIG. 17(A) to FIG. 17(B).

The corrected characteristic amount is compared with each characteristic amount contained in the age and gender dictionary ASDC, and at every time a matching degree exceeds the reference value REF2, the column number of the characteristic amount in the matching destination and the matching degree are registered on the recognized face register RGST3. Upon completion of comparing, a position and a size of the face-detection frame structure corresponding to a maximum matching degree, and an age and a gender described in the column of the age and gender dictionary ASDC indicated by a column number corresponding to the maximum matching degree are registered on the finalization register RGST4.

Upon completion of the age estimating process after converting the position and size of the face-detection frame structure registered in the finalization register RGST4 into the one on the search image data, the CPU 26 executes a beautiful skin process. The beautiful skin process is executed for the image belonging to the face-detection frame structure registered in the finalization register RGST4, based on the age and the gender registered in the finalization register RGST4. In the beautiful skin process, for example, the higher the estimated age is, the more a correction degree is strengthened. Moreover, as to a face image of a female, the correction degree is strengthen than that of a male, and a skin whitening process of correcting a skin color brightly, etc. is also performed.

In an example of FIG. 16, when the face images of the persons H4 and H5 are detected, each of the face images is subjected to the beautiful skin process after estimating the age so as to generate an image P_aft shown in FIG. 18.

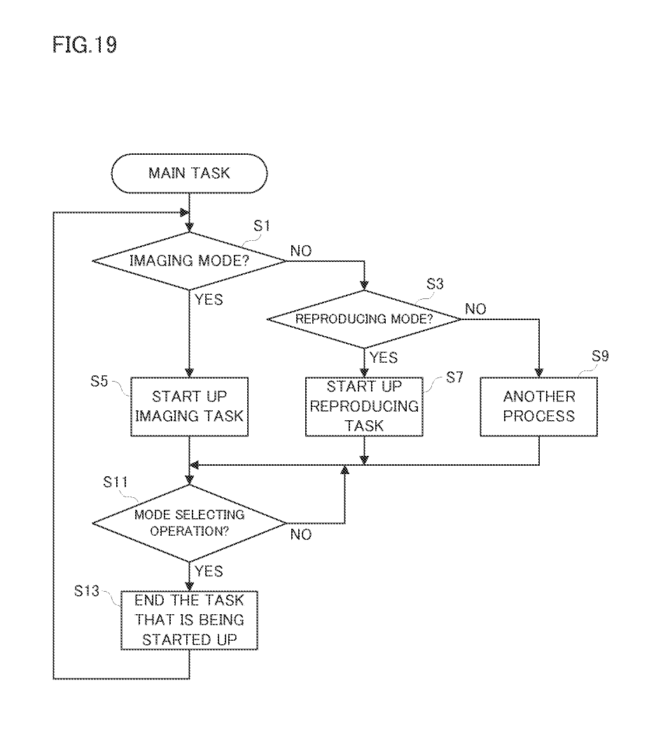

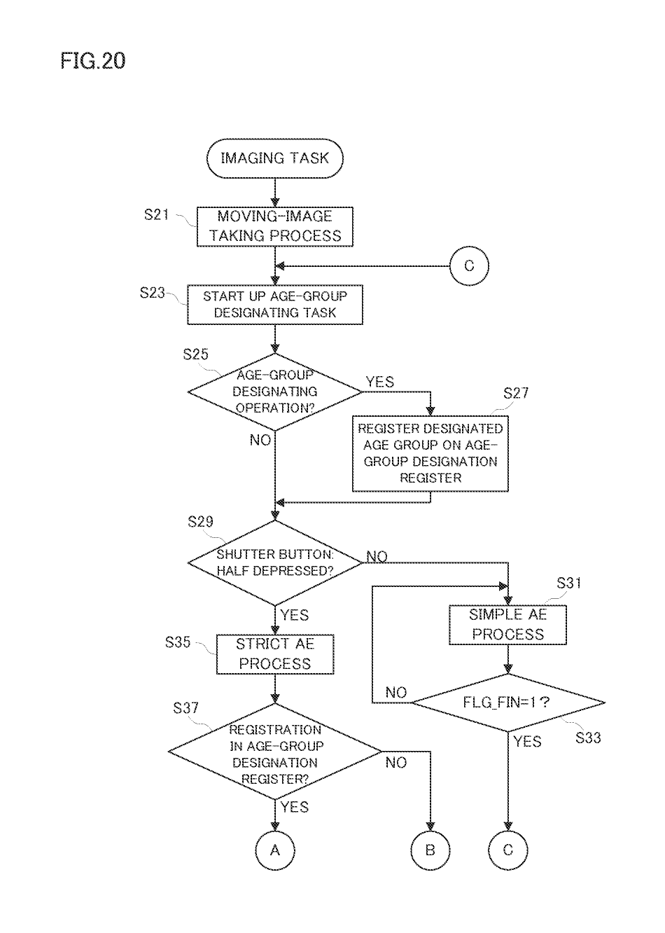

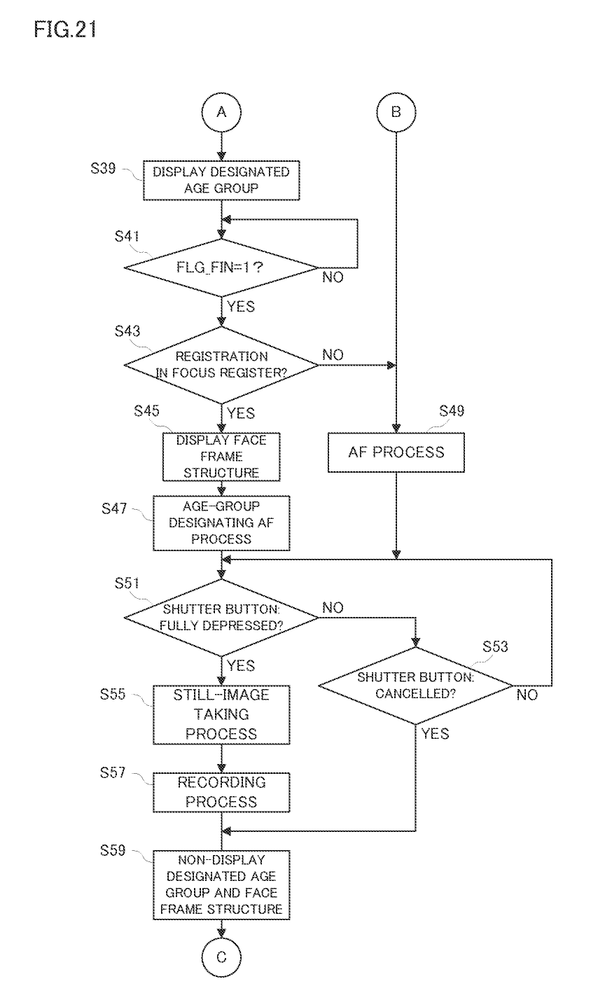

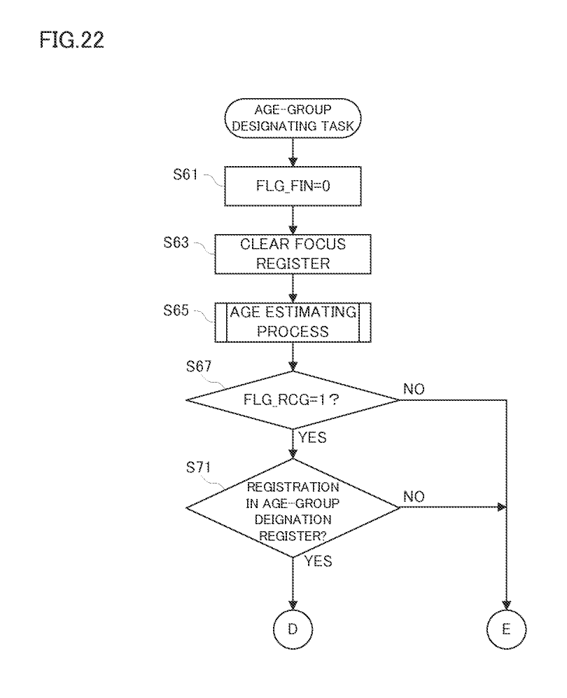

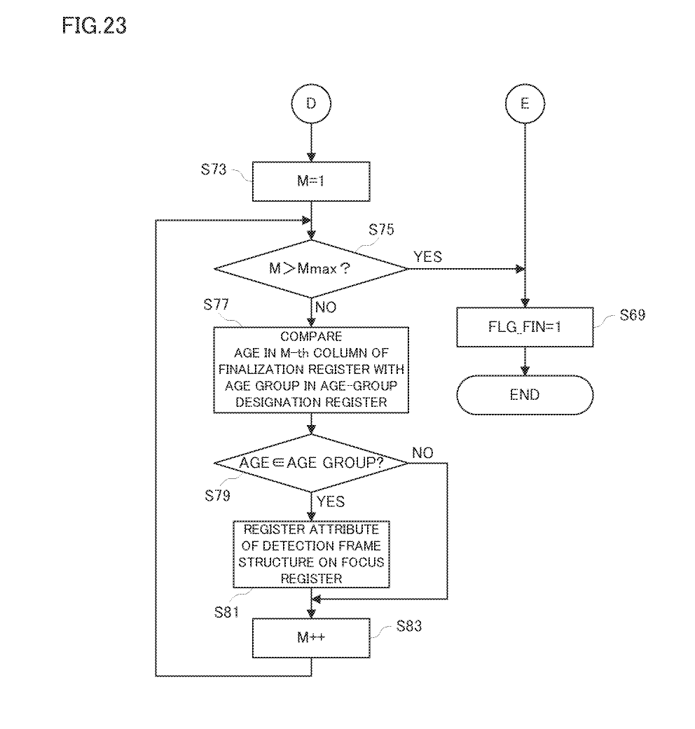

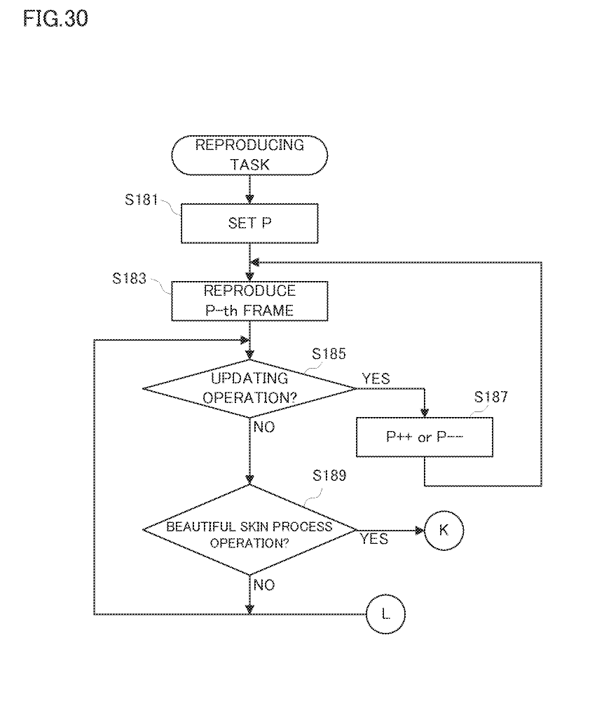

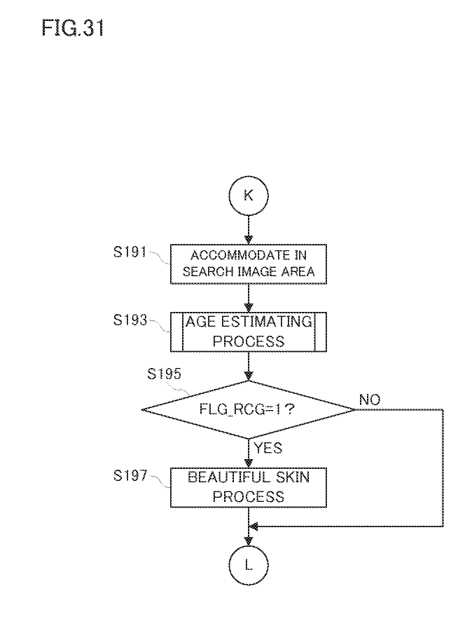

The CPU 26 executes a plurality of tasks including the main task shown in FIG. 19, the imaging task shown in FIG. 20 to FIG. 21, the age-group designating task shown in FIG. 22 to FIG. 23, and the reproducing task shown in FIG. 30 to FIG. 31. It is noted that, control programs corresponding to these tasks are stored in a flash memory 44.

With reference to FIG. 19, in a step S1, it is determined whether or not the operation mode at the current time point is the imaging mode, and in a step S3, it is determined whether or not the operation mode at the current time point is the reproducing mode. When YES is determined in the step S1, the imaging task is started up in a step S5, and when YES is determined in the step S3, the reproducing task is started up in a step S7. When NO is determined in both the steps S1 and S3, another process is executed in a step S9. Upon completion of the processes in the steps S5, S7 or S9, in a step S11, it is repeatedly determined whether or not a mode selecting operation is performed. When a determined result is updated from NO to YES, the task that is being started up is ended in a step S13, and thereafter, the process returns to the step S1.

With reference to FIG. 20, in a step S21, the moving-image taking process is executed. As a result, the live view image representing the scene is displayed on the LCD monitor 38, and the search image data is repeatedly written into the search image area 32c. In a step S23, the age-group designating task is started up, and in a step S25, it is determined whether or not the age-group designating operation is performed by the operator through the key input device 28. When a determined result is NO, the process advances to a step S29 while when the determined result is YES, the designated age group is registered on the age-group designation register RGST1 in a step S27.

In a step S29, it is determined whether or not the shutter button 28sh is half depressed. When a determined result is NO, in a step S31, the simple AE process is executed. The brightness of the live view image is adjusted approximately by the simple AE process.

Under the started-up age-group designating task, a flag FLG_FIN is set to “0” as an initial setting, and is updated to “1” when the process of the age-group designating task is completed. In a step S33, it is repeatedly determined whether or not the flag FLG_FIN is updated to “1”, and as long as a determined result is NO, the simple AE process is repeatedly executed in the step S31. When the determined result of the step S33 is updated from NO to YES, the process returns to the step S23.

When the determined result of the step S29 is YES, in a step S35, the strict AE process is executed. The brightness of the live view image is adjusted to an optimal value by the strict AE process. In a step S37, it is determined whether or not the designated age group is registered in the age-group designation register RGST1, and when a determined result is YES, the process advances to a step S39 so as to issue the designated-age-group display command toward the graphic generator 46. In the designated-age-group display command, the designated age group registered in the age-group designation register RGST1 is described. As a result, the designated age group registered in the age-group designation register RGST1 is displayed at the lower right of the monitor screen with the live view image.

In a step S41, it is repeatedly determined whether or not the flag FLG_FIN indicates “1”, and when a determined result is updated from NO to YES, in a step S43, it is determined whether or not the position and size of the face-detection frame structure are registered in the focus register RGST5. In a step S45, the face-frame-structure display command is issued toward the graphic generator 46. In the face-frame-structure display command, the position and size of the face-detection frame structure registered in the focus register RGST5 is described. As a result, the face-frame structure KF is displayed in a manner to surround the face image of the person having the estimated age belonging to the age group designated in the age-group designating operation.

In a step S47, the AF process giving priority to the face position surrounded by the face-frame structure KF is executed. As a result, a sharpness of the face image surrounded by the face-frame structure KF is improved. When the determined result of the step S37 or S43 is NO, the process advances to a step S49 so as to execute the normal AF process. The focus lens 12 is placed at the focal point by the AF process.

Upon completion of the process in the step S47 or S49, in a step S51, it is determined whether or not the shutter button 28sh is fully depressed, and in a step S53, it is determined whether or not the operation of the shutter button 28sh is cancelled. When YES is determined in the step S51, in a step S55, the still-image taking process is executed, and in a step S57, the recording process is executed. When the determined result of the step S53 is YES, the process advances to a step S59. As a result of the process in the step S55, one frame of the image data representing the scene at the time point at which the shutter button 28sh is fully depressed is taken into the still-image area 32d. Moreover, as a result of the process in the step S57, the image data taken into the still-image area 32d is recorded on the recording medium 42 in the file format.

When the designated age group or the face-frame structure KF is displayed, in the step S59, a designated-age-group non-display command or a face-frame-structure non-display command is applied to the graphic generator 46, and as a result, displaying the designated age group or the face-frame structure KF is cancelled. Thereafter, the process returns to the step S23.

With reference to FIG. 22, in a step S61, the flag FLG_FIN is set to “0”, and in a step S63, the focus register RGST5 is cleared. In a step S65, the age estimating process is executed, and in a step S67, it is determined whether or not the flag FLG_RCG indicates “1”. When a determined result is NO, in a step S69, the flag FLG_FIN is set to “1”, and thereafter, the process is ended. When the determined result is YES, in a step S71, it is determined whether or not the designated age group is registered in the age-group designation register RGST1. When a determined result of the step S71 is NO, the process advances to the step S69 while when the determined result is YES, the variable M is set to “1” in a step S73.

In a step S75, it is determined whether or not the variable M exceeds a maximum value Mmax (=the total number of the registered ages in the finalization register RGST4), and when a determined result is YES, the process advances to the step S69 while when the determined result is NO, the process advances to a step S77. In the step S77, the estimated age described in the M-th column of the finalization register RGST4 is compared with the designated age group registered in the age-group designation register RGST1. In a step S79, as a result of comparing in the step S77, it is determined whether or not the estimated age described in the M-th column of the finalization register RGST4 is included in the designated age group registered in the age-group designation register RGST1. When a determined result is NO, the process advances to a step S83 while when the determined result is YES, in a step S81, the position and size of the face-detection frame structure described in the M-th column of the finalization register RGST4 are registered on the focus register RGST5. In the step S83, the variable M is incremented, and thereafter, the process returns to the step S75.

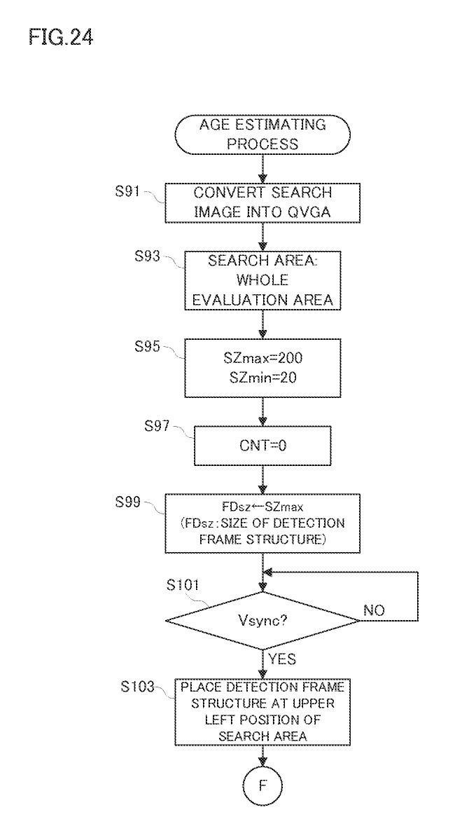

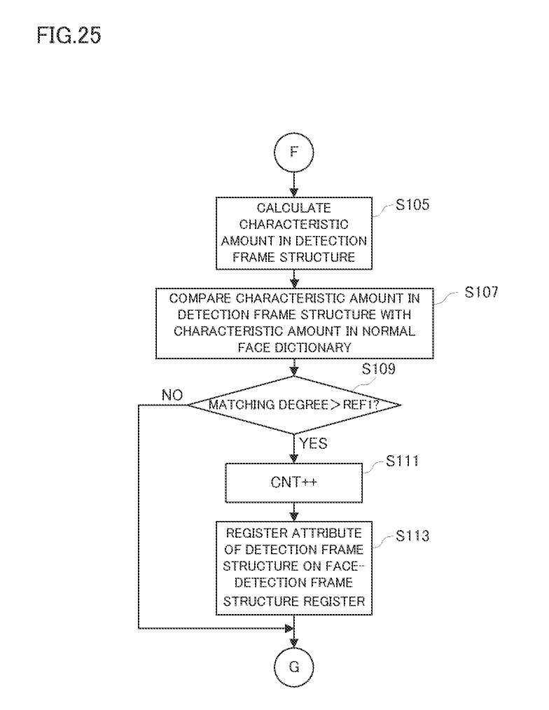

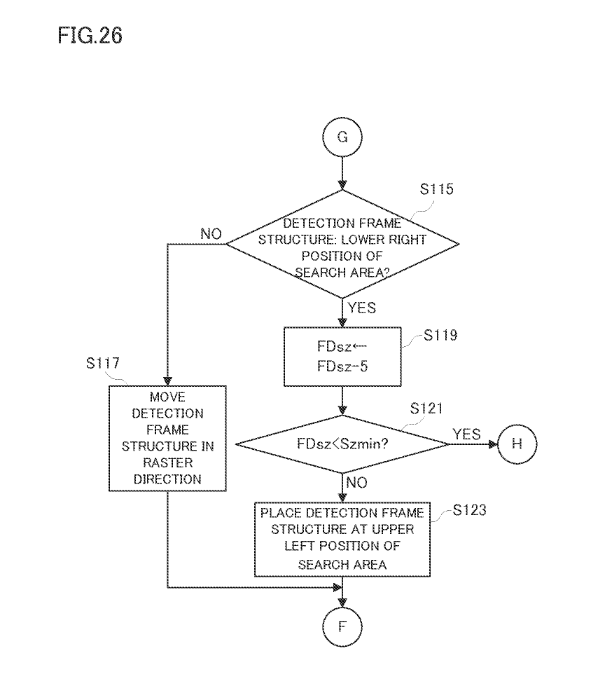

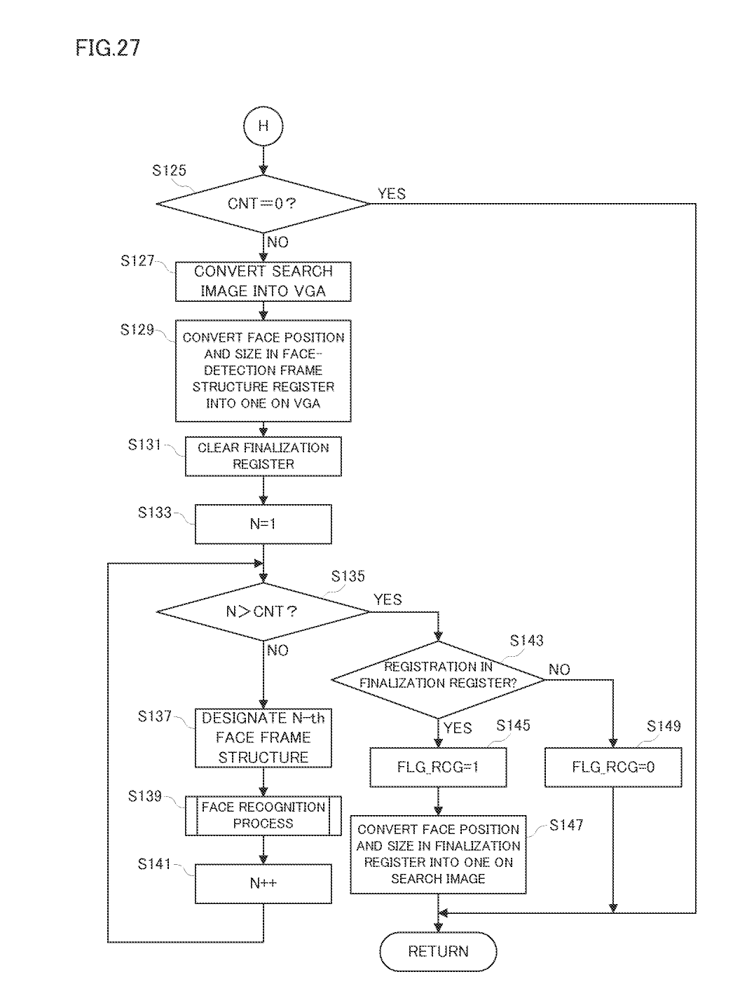

The age estimating process in the step S65 shown in FIG. 22 and a step S193 shown in FIG. 31 are executed according to a subroutine shown in FIG. 24 to FIG. 27. Firstly, in a step S91, the search image data accommodated in the search image area 32c is converted into the QVGA data, and in a step S93, a whole evaluation area EVA is set as a search area. In a step S95, in order to define a variable range of the size of the face-detection frame structure FD, a maximum size SZmax is set to “200”, and a minimum size SZmin is set to “20”. Upon completion of defining the variable range, in a step S97, the variable CNT is set to “0”, and in a step S99, the size of the face-detection frame structure FD is set to “SZmax”.

In a step S101, it is determined whether or not the vertical synchronization signal Vsync is generated. When a determined result is updated from NO to YES, in a step S103, the face-detection frame structure FD is placed at an upper left position of the search area. In a step S105, a part of the QVGA data belonging to the face-detection frame structure FD is read out so as to calculate the characteristic amount of the read-out QVGA data.

In a step S107, the calculated characteristic amount is compared with the characteristic amount of the face image contained in the standard face dictionary STDC, and in a step S109, it is determined whether or not the matching degree exceeds the reference REF 1. When a determined result is NO, the process directly advances to a step S115 while when the determined result is YES, the process advances to the step S115 via steps S111 and S113. In the step S111, the variable CNT is incremented. In the step S113, the position and size of the face-detection frame structure FD at the current time point are registered on the face-detection frame structure register RGST2.

In the step S115, it is determined whether or not the face-detection frame structure FD reaches a lower right position of the search area. When a determined result is NO, in a step S117, the face-detection frame structure FD is moved by a predetermined amount in a raster direction, and thereafter, the process returns to the step S105. When the determined result is YES, in a step S119, the size of the face-detection frame structure FD is reduced by a scale of “5”, and in a step S121, it is determined whether or not the size of the face-detection frame structure FD is less than “SZmin”. When a determined result of the step S121 is NO, in a step S123, the face-detection frame structure FD is placed at the upper left position of the search area, and thereafter, the process returns to the step S105. When the determined result of the step S121 is YES, the process advances to a step S125.

In the step S125, it is determined whether or not the variable CNT is set to “0”, and when a determined result is NO, in a step S127, the search image data accommodated in the search image area 32c is converted into VGA data. When the determined result is YES, the process returns to the routine in an upper hierarchy. In a step S129, the position and size of the face-detection frame structure registered in the face-detection frame structure register RGST2 is converted into the one on the VGA data so as to rewrite the face-detection frame structure register RGST2.

In a step S131, the registered contents in the finalization register RGST4 are cleared, and in a step S133, the variable N is set to “1”. In a step S135, it is determined whether or not the variable N exceeds the variable CNT, and when a determined result is NO, the process advances to a step S137 so as to designate a face-detection frame structure set in an N-th column of the face-detection frame structure register RGST2. In a step S139, the face recognition process in which the image data belonging to the designated-face detection frame structure is noticed is executed. Upon completion of the face recognition process, in a step S141, the variable N is incremented, and thereafter, the process returns to the step S135.

When the determined result of the step S135 is YES, in a step S143, it is determined whether or not there is any registration in the finalization register RGST4. When a determined result of the step S143 is YES, in a step S145, the flag FLG_RCG is set to “1”, and in a step S147, the position and size of the face-detection frame structure registered in the finalization register RGST4 is converted into the one on the search image data so as to rewrite the finalization register RGST4. When the determined result of the step S143 is NO, in a step S149, the flag FLG_RCG is set to “0”. Upon completion of the process in the step S147 or S149, the process returns to the routine in an upper hierarchy.

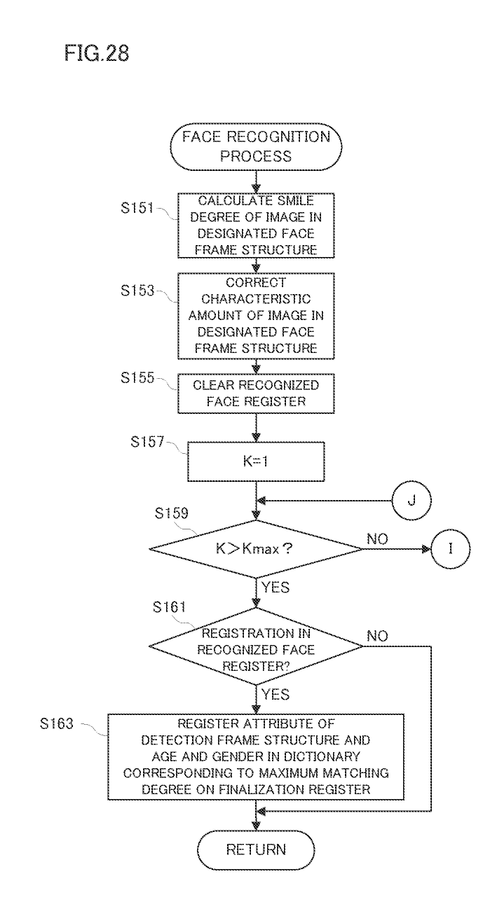

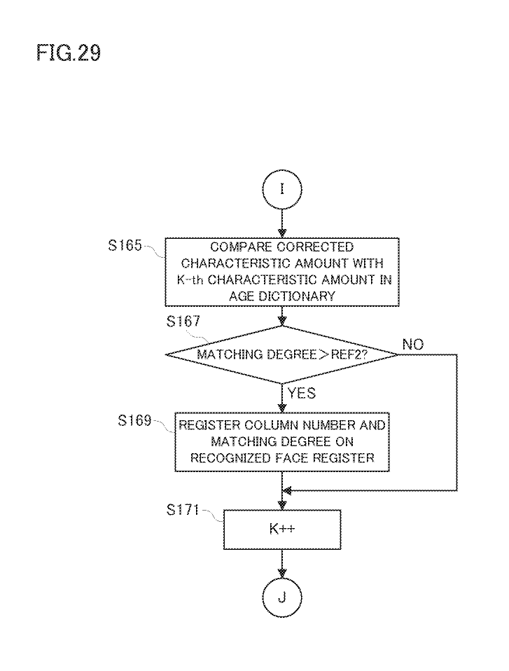

The face recognition process in the step S139 is executed according to a subroutine shown in FIG. 28 to FIG. 29. Firstly, in a step S151, the smile degree of the image data belonging to the designated face-frame structure is calculated, and in a step S153, the characteristic amount of the image data belonging to the designated-face detection frame structure is corrected so that the difference between the calculated smile degree and the smile degree of each characteristic amount contained in the age and gender dictionary ASDC is inhibited or resolved. Since the smile degree of each characteristic amount contained in the age and gender dictionary ASDC is zero, the characteristic amount of the image data belonging to the designated-face detection frame structure is corrected so that the smile degree becomes zero.

In a step S155, the recognized face register RGST3 is cleared, and in a step S157, the variable K is set to “1”. In a step S159, it is determined whether or not the variable K exceeds a maximum value Kmax (=the total number of the characteristic amounts contained in the age and gender dictionary ASDC). When a determined result is NO, the process advances to a step S165 so as to compare the corrected characteristic amount with the characteristic amount described in the K-th column of the age and gender dictionary ASDC.

In a step S167, it is determined whether or not the matching degree exceeds the reference value REF2. When a determined result is YES, the process advances to a step S169 so as to register the column number (=K) of the characteristic amount in the matching destination and the matching degree on the recognized face register RGST3. Upon completion of the registration, in a step S171, the variable K is incremented, and thereafter, the process returns to the step S159. When the determined result of the step S167 is NO, the process returns to the step S159 via the process in the step S171.

When the determined result of the step S159 is YES, it is determined in a step S161 whether or not at least one column number is set in the recognized face register RGST3. When a determined result of the step S161 is YES, in a step S163, the position and size of the face-detection frame structure corresponding to the maximum matching degree, and the age and gender described in the column of the age and gender dictionary ASDC indicated by the column number corresponding to the maximum matching degree are registered on the finalization register RGST4. When a determined result of the step S161 is NO, or upon completion of the process in the step S163, the process returns to the routine in an upper hierarchy.

With reference to FIG. 30, in a step S181, a variable P is set to a number indicating the latest image file, and in a step S183, a P-th frame of the image file recorded in the recording medium 42 is reproduced.

In a step S185, it is determined whether or not an operation for updating a reproduced file is performed by the operator. When a determined result is YES, in a step S187, the variable P is incremented or decremented, and thereafter, the process returns to the step S183. When the determined result is NO, in a step S189, it is determined whether or not the beautiful skin process operation is performed by the operator, and when a determined result is NO, the process returns to the step S185 while when the determined result is YES, the process advances to a step S191.

In the step S191, the image data of the image file under reproduction is written into the search image area 32c of the SDRAM 32, and in the step S193, the age estimating process is executed. In a step S195, it is determined whether or not the flag FLG_RCG is “1”, and when a determined result is NO, the process returns to the step S185 while when the determined result is YES, the process advances to a step S197. In the step S197, the beautiful skin process is executed for the image belonging to the face-detection frame structure registered in the finalization register RGST4, based on the age or the gender registered in the finalization register RGST4. Upon completion of the beautiful skin process, the process returns to the step S185.

As can be seen from the above-described explanation, the CPU 26 takes the image (16, S181 to 187), searches for the one or at least two face images from the taken image (S93 to S123), and designates each of the one or at least two discovered face images (S137). Moreover, the CPU 26 holds the plurality of face characteristics respectively corresponding to the plurality of ages (44) and detects the facial expression of the designated face image. Moreover, the CPU 26 estimates the age of the person equivalent to the designated face image based on the held plurality of face characteristics and the detected facial expression (S153 to S163, S165 to S171), and adjusts the quality of the taken image with reference to the estimated result (S47, S197).

Upon estimating the age of the face image, in addition to the plurality of face characteristics respectively corresponding to the plurality of ages, the facial expression of the face image which is the target of the estimation is referred to. By adjusting the quality of the image with reference to the age thus estimated, the quality of the image is improved.

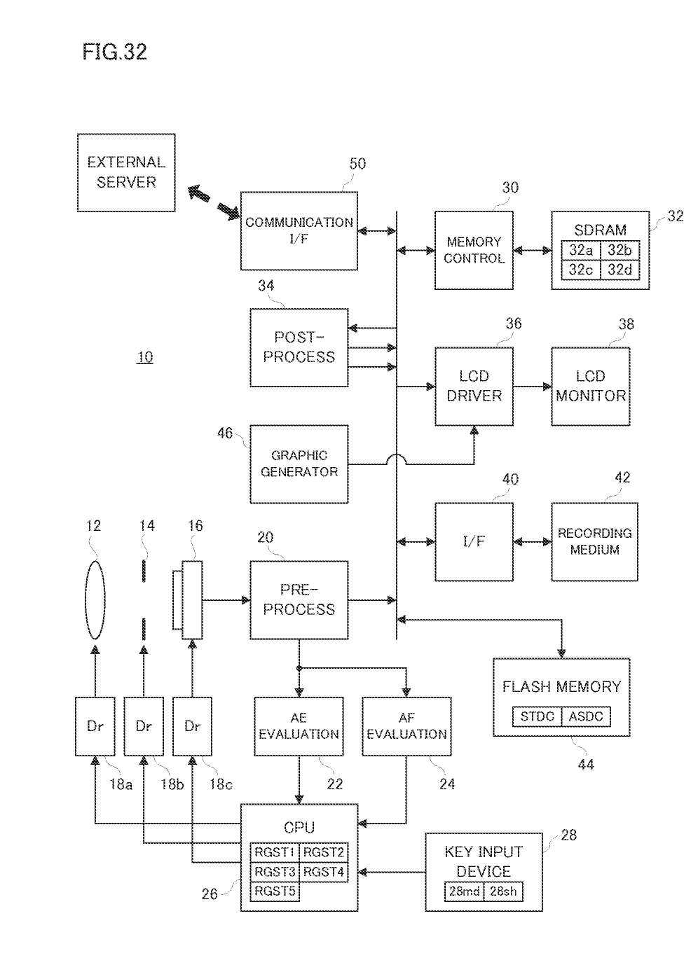

It is noted that, in this embodiment, the control programs equivalent to the multi task operating system and the plurality of tasks executed thereby are previously stored in the flash memory 44. However, a communication I/F 50 for connecting to the external server may be arranged in the digital camera 10 as shown in FIG. 32 so as to initially prepare a part of the control programs in the flash memory 44 as an internal control program while acquire another part of the control programs from the external server as an external control program. In this case, the above-described procedures are realized in cooperation with the internal control program and the external control program.

Moreover, in this embodiment, the processes executed by the CPU 26 are divided into the main task shown in FIG. 19, imaging task shown in FIG. 20 to FIG. 21, the age-group designating task shown in FIG. 22 to FIG. 23 and the reproducing task shown in FIG. 30 to FIG. 31. However, these tasks may be further divided into a plurality of small tasks, and furthermore, a part of the divided plurality of small tasks may be integrated into the main task. Moreover, when a transferring task is divided into the plurality of small tasks, the whole task or a part of the task may be acquired from the external server.

Moreover, in this embodiment, the characteristic amount of the face image belonging to the designated-face detection frame structure is corrected in order to inhibit or resolve the difference between the smile degree calculated in the step S151 and the smile degree of each characteristic amount contained in the age and gender dictionary ASDC. However, instead of the characteristic amount of the face image belonging to the designated-face detection frame structure, or together with the characteristic amount of the face image belonging to the designated-face detection frame structure, the K-th characteristic amount contained in the age and gender dictionary ASDC may be corrected. Moreover, the characteristic amount of the corrected face image may be detected by regarding the face image belonging to the designated-face detection frame structure, not the characteristic amount, as a target of correction.

Moreover, in this embodiment, the age and gender dictionary ASDC which contains a characteristic amount of an average face image of each age of the male together with a characteristic amount of an average face image of each age of the female is used. However, the gender may be determined by comparing the corrected characteristic amount with the characteristic amount in the gender dictionary before estimating the age, based on a gender dictionary which contains a characteristic amount of an average face image of the male and a characteristic amount of an average face image the of female. In this case, only the characteristic amount of the determined gender may be compared with the age and gender dictionary ASDC.

Although the present invention has been described and illustrated in detail, it is clearly understood that the same is by way of illustration and example only and is not to be taken by way of limitation, the spirit and scope of the present invention being limited only by the terms of the appended claims.

What is claimed is:

1. An image processing apparatus, comprising:
a taker which takes an image;
a searcher which searches for one or at least two face images from the image taken by said taker;
a first designator which designates each of the one or at least two face images discovered by said searcher;
a holder which holds a plurality of face characteristics respectively corresponding to a plurality of ages;
a detector which detects a facial expression of the face image designated by said first designator;
an estimator which estimates an age of a person equivalent to the face image designated by said first designator, based on the plurality of face characteristics held by said holder and the facial expression detected by said detector; and
an adjuster which adjusts a quality of the image taken by said taker with reference to an estimated result of said estimator.

2. An image processing apparatus according to claim 1, wherein said taker includes an imager which outputs the image representing a scene captured on an imaging surface, and said adjuster includes an imaging condition adjuster which adjusts an imaging condition.

3. An image processing apparatus according to claim 2, further comprising a second designator which designates any one of the plurality of ages, wherein said imaging condition adjuster adjusts the imaging condition by using a face image of a person having an age corresponding to the age designated by said second designator as a reference.

4. An image processing apparatus according to claim 1, wherein said taker includes a reproducer which reproduces the image from a recording medium, and said adjuster includes a smoothing processor which performs a smoothing process on each face image discovered by said searcher.

5. An image processing apparatus according to claim 1, wherein said estimator includes a face characteristic corrector which corrects a characteristic of the face image designated by said first designator and/or each of the plurality of face characteristics held by said holder with reference to the facial expression detected by said detector, and a face characteristic detector which executes, after a correcting process of said face characteristic corrector, a process of detecting a face characteristic coincident with the characteristic of the face image designated by said first designator from among the plurality of face characteristics held by said holder.

6. A computer program embodied in a tangible medium, which is executed by a processor of an image processing apparatus, said program comprising:
a taking instruction to take an image;
a searching instruction to search for one or at least two face images from the image taken based on said taking instruction;
a first designating instruction to designate each of the one or at least two face images discovered based on said searching instruction;
a holding instruction to hold a plurality of face characteristics respectively corresponding to a plurality of ages;
a detecting instruction to detect a facial expression of the face image designated based on said first designating instruction;
an estimating instruction to estimate an age of a person equivalent to the face image designated based on said first designating instruction, based on the plurality of face characteristics held based on said holding instruction and the facial expression detected based on said detecting instruction; and
an adjusting instruction to adjust a quality of the image taken based on said taking instruction with reference to an estimated result based on said estimating instruction.

7. An imaging control method executed by an image processing apparatus, said imaging control method, comprising:
a taking step of taking an image;
a searching step of searching for one or at least two face images from the image taken by said taking step;
a first designating step of designating each of the one or at least two face images discovered by said searching step;
a holding step of holding a plurality of face characteristics respectively corresponding to a plurality of ages;
a detecting step of detecting a facial expression of the face image designated by said first designating step;
an estimating step of estimating an age of a person equivalent to the face image designated by said first designating step, based on the plurality of face characteristics held by said holding step and the facial expression detected by said detecting step; and
an adjusting step of adjusting a quality of the image taken by said taking step with reference to an estimated result of said estimating step.
